(19) United States
(12) Patent Application Publication
(10) Pub. No.: US 2021/0369417 A1
(43) Pub. Date: Dec. 2, 2021

(54) BRACKET ATTACHMENT SYSTEM

(71) Applicant: uLab Systems, Inc., San Mateo, CA (US)

(72) Inventors: Huafeng WEN, Redwood Shores, CA (US); Amir A. ABOLFATHI, Petaluma, CA (US)

(73) Assignee: uLab Systems, Inc., San Mateo, CA (US)

(21) Appl. No.: 17/228,406

(22) Filed: Apr. 12, 2021

Related U.S. Application Data
(60) Provisional application No. 63/032,986, filed on Jun. 1, 2020.

(51) Int. Cl. A61C 7/34

(52) U.S. Cl. CPC A61C 7/34

(57) ABSTRACT

A bracket attachment system is described herein. One variation of an orthodontic bracket assembly generally comprises a main body having a contact surface for placement against a surface and defining a wire slot therethrough. A covering having a retention member configured to be inserted at least partially into the wire slot when the covering is positioned upon the main body may be included such that when a wire is positioned within the wire slot, the wire may be retained via the retention member in a secured position.

### CROSS-REFERENCE TO RELATED APPLICATIONS

This application claims the benefit of priority to U.S. Prov. 63/032,986 filed Jun. 1, 2020, which is incorporated herein by reference in its entirety.

### FIELD OF THE INVENTION

The present invention relates to methods and apparatus for orthodontics. More particularly, the present invention relates to methods and apparatus for orthodontic brackets which may also function as attachments to correcting malocclusions.

### BACKGROUND OF THE INVENTION

Orthodontics is a specialty of dentistry that is concerned with the study and treatment of malocclusions which can result from tooth irregularities, disproportionate facial skeleton relationships, or both. Orthodontics treats malocclusion through the displacement of teeth via bony remodeling and control and modification of facial growth.

This process has been traditionally accomplished by using static mechanical force to induce bone remodeling, thereby enabling teeth to move. In this approach, braces having an archwire interface with brackets are affixed to each tooth. As the teeth respond to the pressure applied via the archwire by shifting their positions, the wires are again tightened to apply additional pressure. This widely accepted approach to treating malocclusions takes about twenty-four months on average to complete, and is used to treat a number of different classifications of clinical malocclusion. Treatment with braces is complicated by the fact that it is uncomfortable and/or painful for patients, and the orthodontic appliances are perceived as unaesthetic, all of which creates considerable resistance to use. Further, the treatment time cannot be shortened by increasing the force, because too high a force results in root resorption, as well as being more painful. The average treatment time of twenty-four months is very long, and further reduces usage. In fact, some estimates provide that less than half of the patients who could benefit from such treatment elect to pursue orthodontics.

Kesling introduced the tooth positioning appliance in 1945 as a method of refining the final stage of orthodontic finishing after removal of the braces (debonding). The positioner was a one-piece pliable rubber appliance fabricated on the idealized wax set-ups for patients whose basic treatment was complete. Kesling also predicted that certain major tooth movements could also be accomplished with a series of positioners fabricated from sequential tooth movements on the set-up as the treatment progressed. However, this idea did not become practical until the advent of three-dimensional (3D) scanning and use of computers by companies including Align Technologies and as well as OrthoClear, ClearAligner, and ClearCorrect to provide greatly improved aesthetics since the devices are transparent.

However, these aligners may not be suitable or they may be inadequate to correct many different types of malocclusions. Some treatments may require the use of an archwire traditionally used with braces. Also, the treatments may require the use of attachments where different types of attachments may be used with aligners to facilitate the movement of particular teeth. The attachments may be bonded upon the surface of a crown and they may be shaped in various configurations and positioned in different orientations depending upon the movement to be imparted to the tooth.

However, corrections which are optimally performed by a combination of an archwire and/or treatment using attachments with aligners may require two different treatment types which add to costs, patient discomfort, and treatment times. Accordingly, there exists a need for efficiently and effectively performing treatments which facilitate both an archwire and attachment use for moving of one or more teeth.

### SUMMARY OF THE INVENTION

Braces are systems used to align teeth having a wire component and brackets to hold the wire in place upon the teeth of the patient. Such brackets can be either made of stainless steel, ceramic, or other biocompatible materials which are usually prefabricated to the different forms to adapt the particular type of teeth. Different wires may be placed in the bracket slots. These brackets may incorporate self-ligating features which do not require any other mechanisms such as rubber bands. Orthodontists, using different sets of wire, may sometimes bend the wire into different shape to place them into the bracket slots in order to gradually align the teeth via the forces exerted from the wire. Because treatment with braces typically require a high level of technical skill, a fabricated splint, e.g., 3D printed, which function as brackets may be used to easily install, remove, or reposition the brackets.

In many aligner cases, attachments may be used to increase the contact areas on one or more of the tooth crowns to augment the grip of an aligner upon the teeth of a patient. The shape and mechanics of the attachments that imparts the force and torque to the teeth, and the software algorithms that place the attachments on crowns, defines the application and function of a particular attachment.

To place the attachment on a tooth crown, the software may be used to first detect what movements are imparted to the tooth. There may be multiple movements programmed on the tooth simultaneously. The software may be used to determine for which movement the attachment will be placed, where the attachment will be placed on the tooth crown, what direction the active surface will be oriented by a protocol, which should have all the constraints that make the attachment feasible for 3D printing and thermoforming, including but not limited to margins to the occlusal, gingival, distal, and mesial sides, the maximal prominence on the crown. The shape, position, prominence, and orientation of the attachment may be generated by software, such as UDESIGN by uLab Systems, Inc. (San Mateo, Calif.), as described herein.

One variation of a bracket system which may be comprised of multiple components may be fabricated using, e.g., 3D printing techniques. These brackets may have a bracket main body having a longitudinal length for securing upon the crowns of a patient's teeth. The main body may each define a wire slot which extends in a direction transverse to the longitudinal axis of the main body to accommodate the insertion of a wire. The main body may be secured to the crowns which require treatment using the wire.

Once the main body has been suitably secured to the crowns of interest, a wire may be inserted into the wire slots of each main body and a flexible covering which is designed to conform to the main body may be attached over and secured upon the main body to retain and secure the wire within each wire slot, e.g., via press fit, adhesives, various other locking mechanisms. The main body and/or covering may be fabricated from any number of materials such as metals or polymers which can allow for the fabrication of the components using, e.g., 3D printing.

In yet another variation, the main body or any number of other conventional bracket and/or attachment features may be utilized in a multi-component attachment system. A first component may generally comprise a pad such as a bracket pad having an interface surface and one or more locking and/or registration features for attachment with any number of second components. The first component may further have an attachment surface opposite to the interface surface for securement to the surface of a crown using any number of attachment mechanisms such as adhesives.

The second component may have one or more corresponding registration features for insertion and/or alignment with the underlying locking and/or registration features of the first component. The second component may be aligned and secured to the first component via any number of securement mechanisms. Once the second component has been secured to the first component, the main body may be used as described herein or any other second component may be used as designed for its intended purpose.

### BRIEF DESCRIPTION OF THE DRAWINGS

FIGS. 1A and 1B show a front view of a multi-component bracket placed upon the teeth of a patient.

FIG. 1C shows another example where the multi-component bracket may also be used as attachments for use with an aligner.

FIGS. 2A to 2C show side views of one variation of a bracket main body and the covering.

FIG. 2D shows a side view of another variation of the bracket main body and another variation of the covering.

FIGS. 3A to 3C show top, side, and bottom views, respectively of a first component which is attachable to the surface of a crown.

FIGS. 4A and 4B show side views of one variation of a second component which may be attached to the first component.

FIGS. 5A to 5C show side views of another variation where a second component may be removed from the first component and another configuration of the second component may be installed for a combination treatment.

FIGS. 6A to 6C show side views of different configurations for the second component which may be used for bracket treatments with a wire.

FIGS. 7A to 7C show side views of different configurations for the second component which may be used as attachments for use with an aligner.

### DETAILED DESCRIPTION OF THE INVENTION

Braces are systems used to align teeth having a wire component and brackets to hold the wire in place upon the teeth of the patient. Such brackets can be either made of stainless steel, ceramic, or other biocompatible materials which are usually prefabricated to the different forms to adapt the particular type of teeth. Different wires may be placed in the bracket slots. These brackets may incorporate self-ligating features which do not require any other mechanisms such as rubber bands. Orthodontists, using different sets of wire, may sometimes bend the wire into different shape to place them into the bracket slots in order to gradually align the teeth via the forces exerted from the wire. Because treatment with braces typically require a high level of technical skill, a fabricated splint, e.g., 3D printed, which function as brackets may be used to easily install, remove, or reposition the brackets.

In designing an orthodontic attachment for use with an aligner in correcting for malocclusions, the orthodontic attachment may be initially designed utilizing the clinical experience of a practitioner such as an orthodontist and the attachment design may be subsequently optimized through machine learning. The various orthodontic brackets and/or attachments may be designed utilizing automated design software (e.g., UDESIGN, uLab Systems, Inc., San Mateo, Calif.) and forming processes such as those developed by uLab Systems, Inc. These software and forming processes which may be used with the bracket and attachment components described herein are further described in U.S. Pat. Pubs. 2017/0100207; 2017/0100208; 2017/0100209; 2017/0100210; 2017/0100211; 2018/0078347; 2018/0078343; 2018/0078344; 2018/0078335; 2017/0100214, each of which is incorporated herein by reference in its entirety. The attachments described herein may also be used with any number of other teeth planning treatment systems such as those produced by Align Technologies, Inc. (San Jose, Calif.).

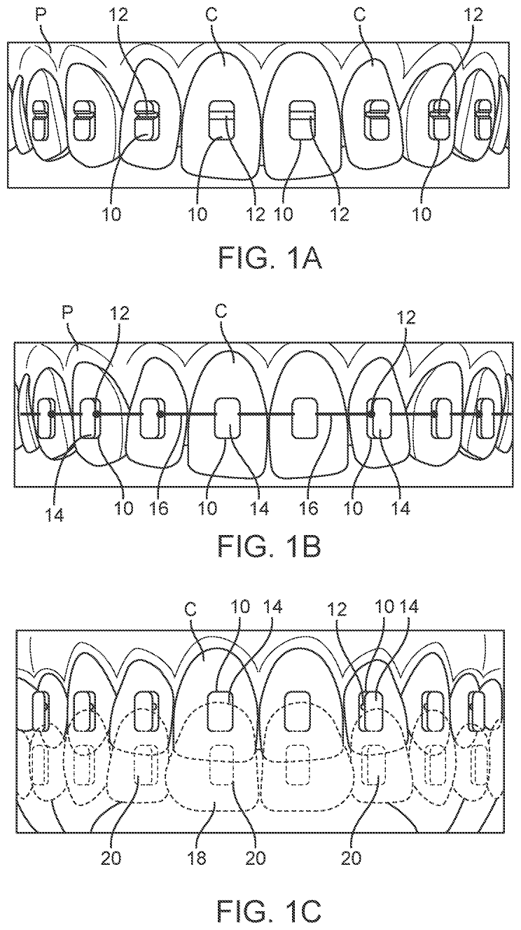

FIGS. 1A to 1C show front views of one variation of a bracket system which may be comprised of multiple components which may be fabricated using, e.g., 3D printing techniques. These brackets may have a bracket main body 10 having a longitudinal length for securing upon the crowns of a patient's P teeth, as shown in FIG. 1A. The main body 10 may each define a wire slot 12 which extends in a direction transverse to the longitudinal axis of the main body 10 to accommodate the insertion of a wire. The main body 10 may be secured to the crowns which require treatment using the wire.

Once the main body 10 has been suitably secured to the crowns C of interest, a wire 16 may be inserted into the wire slots 12 of each main body 10 and a flexible covering 14 which is designed to conform to the main body 10 may be attached over and secured upon the main body 10 to retain and secure the wire 16 within each wire slot 12, e.g., via press fit, adhesives, various other locking mechanisms, etc., as shown in FIG. 1B. The main body 10 and/or covering 14 may be fabricated from any number of materials such as metals or polymers which can allow for the fabrication of the components using, e.g., 3D printing.

Additionally and/or alternatively, the main body 10 and covering 14 may also be designed to incorporate one or more active surfaces which may allow for the main body 10 and covering 14 to be used as attachments in combination with an aligner, if so desired. In this manner, the main body 10 and covering 14 may incorporate the one or more active surfaces for engagement with the aligner when placed upon the teeth for selectively urging a number of specified movements to the tooth or teeth of interest. An example is illustrated in FIG. 1C which shows the main body 10 and covering 14 in place upon the crowns with the wire 16 subsequently removed. The aligner 18 is shown ready to be positioned upon the patient's dentition where the aligner 18 may define one or more receiving pockets or channels 20 for positioning over the corresponding main body 10 and covering 14 to selectively contact against active surfaces of the main body 10.

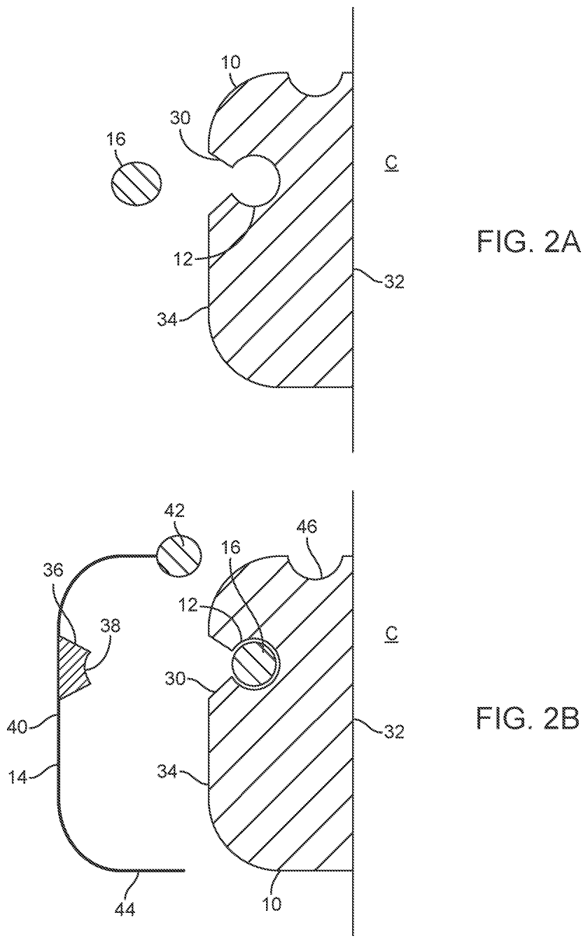

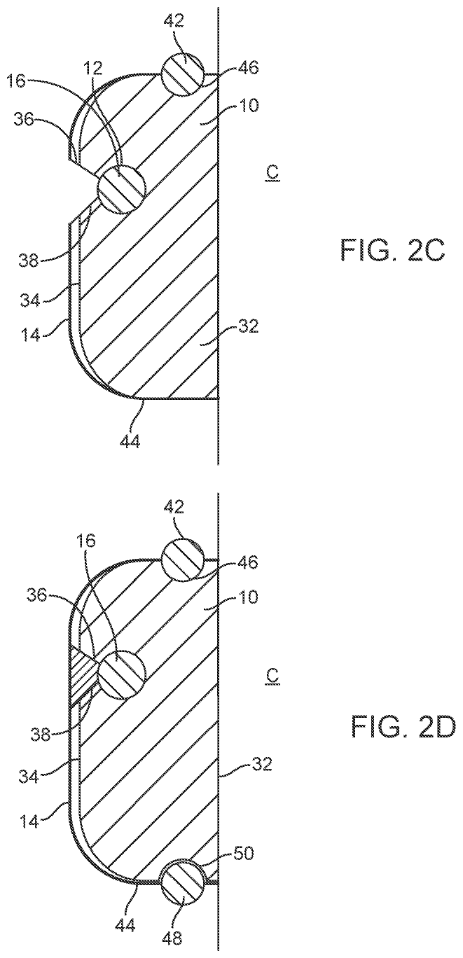

Turning now to FIGS. 2A to 2C, side views of an example of the main body 10 are illustrated. FIG. 2A shows the main body 10 which may be secured to, e.g., a buccal or lingual surface of the crown C, via a contact surface 32 of the main body. The main body 10 may define the wire slot 12 to extend transversely through the main body 10 which may further define a tapered receiving channel 30 which may facilitate the introduction of the wire 16 (shown in cross-section) through the tapered receiving channel 30 and into the wire slot 12 which may have a diameter which is larger, equivalent, or slightly smaller than a diameter of the wire 16 in order to function as a self-ligating bracket to retain the wire 16 in place.

Once the wire 16 has been suitably positioned within the wire slot 12, the covering 14 may be placed upon the main body 10 and secured into place. The covering 14 may have a surface 40 which conforms closely to the interface surface 34 of the main body 10 and may extend from a first end which may curve in a shape to conform to a first end of the main body 10 and terminate in a retaining feature 42, e.g., a ball-like feature or shoulder, which may be received by a receiving channel or undercut 46 defined at the first end of the main body 10. A second end of the covering 14 may similarly curve into a retaining feature 44 which likewise conforms to the second end of the main body 10 to facilitate the securement of the covering 14 upon the main body 10. A cork-like feature or retaining member 36 may extend from the inner surface of the covering 14 and terminate in a contact surface 38 in a shape which corresponds to the tapered wire receiving channel 30 such that when retaining feature 42 is positioned within the channel or undercut 46 and the curved retaining feature 44 is secured upon the second end of the main body 10, the retaining member 36 may extend into the receiving channel 30 such that the contact surface 38 pushes against or upon the wire 16, as shown in FIG. 2C, to self-ligate the wire 16.

In the event that the main body 10 and covering 14 are also optionally utilized as attachment features for use with an aligner, the outer surface of the and main body 10 and conforming covering 14 may incorporate one or more active surfaces designed to contact against the aligner to impart specified movements to the crown C. The contact surface 34 of the main body 10 and/or the inner surface of the covering 14 may optionally incorporate an adhesive or other features to facilitate the attachment between the main body 10 and the covering 14 in this and the other variations described herein. In order to remove the covering 14 from the main body 10, the covering 14 may be pressed down from one end upon the main body 10 allowing for the lifting of the covering 14 from its side to flex it outward to unlock it from the main body 10.

Another variation is shown in the side view of FIG. 2D which may incorporate a second retaining feature 48 at the terminal end of the curved retaining feature 44 for securement within the undercut 50 defined within the main body 10.

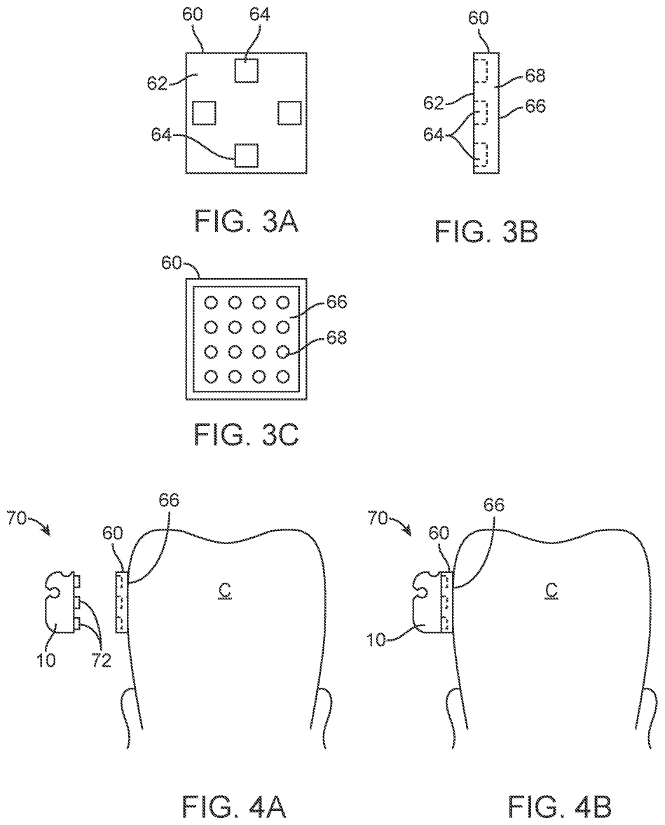

In yet another variation, the main body 10 described herein or any number of other conventional bracket and/or attachment features may be utilized in a multi-component attachment system. As shown in the top, side, and bottom views of FIGS. 3A to 3C, a first component 60 may generally comprise a pad such as a bracket pad having an interface surface 62 and one or more locking and/or registration features 64 for attachment with any number of second components, as further described herein. The first component 60 may further have an attachment surface 66 opposite to the interface surface 62 for securement to the surface of a crown C using any number of attachment mechanisms such as adhesives. The attachment surface 66 may further define any number of features 68 such as pores, projections, etc. which help to facilitate the attachment of the first component 60 to the surface of the crown C.

As shown in the side views of FIGS. 4A and 4B, an example of a first component 60 is shown as having been attached to the crown surface, e.g., buccal or lingual surface. The second component 70 is illustrated in this example as a main body 10 having one or more corresponding registration features 72 for insertion and/or alignment with the underlying locking and/or registration features 64 of the first component, as shown in FIG. 4A. The second component 70 may be aligned and secured to the first component 60 via any number of securement mechanisms, e.g., press-fit, adhesives, etc., as shown in FIG. 4B. Once the second component 70 has been secured to the first component 60, the main body 10 may be used as described herein or any other second component 70 may be used as designed for its intended purpose.

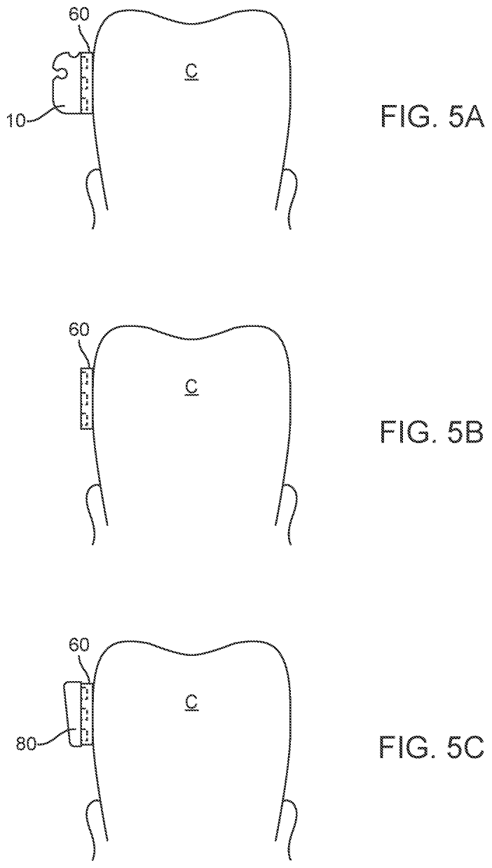

In yet another example, FIGS. 5A to 5C show side views of a first component 60 secured to the surface of a crown C. A main body 10, or any number of other bracket configurations incorporating a locking and/or registration feature for securement to the first component 60, may be used for treating a patient with a wire for imparting movements to the tooth or teeth, as shown in FIG. 5A. Once the first portion of the treatment is completed, the second component may be removed from the first component 60, as shown in FIG. 5B. Another second component having the same locking and/or registration feature, this time an attachment 80 for imparting a movement to the teeth when used with an aligner may be secured to the first component 60 for continuing a second portion of the treatment, as shown in FIG. 5C. In this manner, the first component 60 may be maintained upon the crown C without having to be removed and reattached to treat the patient.

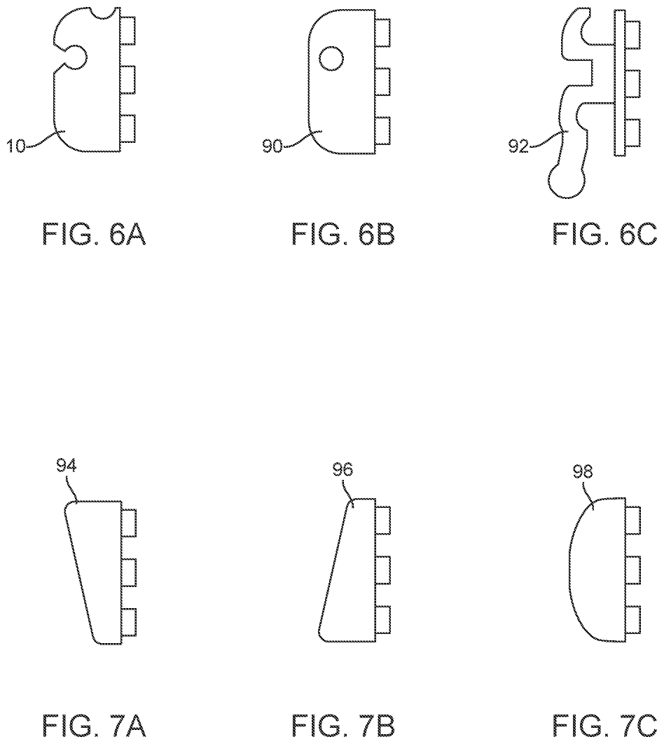

FIGS. 6A to 6C illustrate side views of examples of the various types of bracket configurations which may be used for attachment to the first component 60. FIG. 6A shows a side view of the main body 10 described herein and having the locking and/or registration features incorporated. FIG. 6B shows another example of a bracket 90 incorporating an eyelet for receiving a wire therethrough and FIG. 6C shows yet another example of a bracket 92 also incorporating the locking and/or registration feature for use with rubber bands.

FIGS. 7A to 7C illustrate side views of additional examples of the various types of attachment configurations which may be used for attachment to the first component 60. Each of the figures illustrate attachments 94, 96, 98 which may be designed to impart any number of movements to the teeth when used with an aligner depending upon the desired type of movement.

These examples of the various types of second components are intended only to be illustrative of the different configurations which may be used so long as the components incorporate the locking and/or registration features for proper alignment to the first component 60.

The applications of the devices and methods discussed above are not limited to the one described but may include any number of further treatment applications. Modification of the above-described assemblies and methods for carrying out the invention, combinations between different variations as practicable, and variations of aspects of the invention that are obvious to those of skill in the art are intended to be within the scope of the claims.

What is claimed is:

1. An orthodontic bracket assembly, comprising:
a main body having a contact surface for placement against a surface and defining a wire slot therethrough;
a covering having a retention member configured to be inserted at least partially into the wire slot when the covering is positioned upon the main body;
wherein a wire positioned within the wire slot is retained via the retention member in a secured position.

2. The assembly of claim 1 wherein the wire slot is defined to be transverse to a longitudinal axis of the main body.

3. The assembly of claim 1 wherein the main body is configured as an attachment having at least one active surface for contacting against an aligner.

4. The assembly of claim 1 wherein the covering is shaped to conform to a configuration of the main body.

5. The assembly of claim 1 further comprising a first component having a contact surface for attachment against a surface of a crown and an interface surface for placement against the surface of the main body.

6. The assembly of claim 5 wherein the main body further comprises one or more registration and/or locking members for alignment with the first component.

7. A method of treatment, comprising:
attaching at least one main body against a surface of a crown;
positioning a wire within a wire slot defined through the main body;
securing a covering over the main body such that the wire is retained within the wire slot.

8. The method of claim 7 further comprising removing the wire from the wire slot while the at least one main body remains attached against the surface of the crown.

9. The method of claim 8 further comprising placing an aligner over the crown such that an active surface of the main body contacts at least one surface of the aligner.

10. An orthodontic assembly, comprising:
a first component having an attachment surface for securement against a surface of a crown and an interface surface opposite of the attachment surface, wherein the interface surface defines one or more registration and/or locking features;
a second component having an orthodontic component for effecting an orthodontic treatment, wherein the second component comprises one or more registration and/or locking features which correspond to the interface surface of the first component.

11. A method for orthodontic treatment, comprising:
securing a first component against a surface of a crown such that an interface surface is exposed and defines one or more registration and/or locking features;
attaching a second component having an orthodontic component for effecting an orthodontic treatment to the first component via one or more registration and/or locking features which correspond to the interface surface of the first component;
removing the second component from the first component while the first component remains secured to the surface of the crown;
attaching another second component having another orthodontic component for effecting another orthodontic treatment to the first component.
